(19) United States
(12) Patent Application Publication
(10) Pub. No.: US 2022/0355232 A1
(43) Pub. Date: Nov. 10, 2022

(54) PROCESS TO MAKE A CERAMIC FILTER FOR METAL CASTING

(71) Applicant: GM Global Technology Operations LLC, Detroit, MI (US)

(72) Inventors: Qigui Wang, Rochester Hills, MI (US); Andrew Thomas Cunningham, Royal Oak, MI (US); Zach Steffes, West Bloomfield, MI (US); Brennon L. White, Novi, MI (US); Liang Wang, Rochester Hills, MI (US)

(21) Appl. No.: 17/307,290

(22) Filed: May 4, 2021

(51) Int. Cl. B01D 39/20; B22D 11/119; C04B 38/00; B28B 1/00

(52) U.S. Cl. CPC B01D 39/2093; B22D 11/119; C04B 38/0096; B28B 1/001; B01D 2252/10; B01D 2201/32; B01D 2201/307; B01D 2201/18

(57) ABSTRACT

A ceramic foam filter system includes a filter body having multiple tortuous path channels through the filter body to filter a molten liquid. A filter holder configuration defining a canister in a runner passage receives the filter body. An upstream end of the filter body receives the molten liquid having multiple inclusions. A predominant portion of the inclusions are larger than the multiple tortuous path channels and are trapped against the upstream end of the filter body. The multiple tortuous path channels are sized to trap a predominant portion of multiple oxides within the molten liquid as trapped oxides within the filter body. A filtered molten material having the multiple inclusions and the multiple oxides removed is directed from the multiple tortuous path channels as a discharge flow to exit at a downstream end of the filter body.

### INTRODUCTION

The present disclosure relates to ceramic filters used in metal casting operations to remove inclusions and oxides in the liquid metal during metal pour.

Components such as cylinder heads for automobile vehicle engines are commonly cast using a semi-permanent mold which is filled with molten metal such as aluminum which is gravity fed into the mold. A semi-permanent mold (SPM) involves a casting process, which may produce aluminum alloy castings from re-usable metal molds and sand cores to form internal passages within the resulting casting. Liquid metal casting operations are used for example to pour liquid aluminum into a mold to produce automobile vehicle engine blocks and engine block components such as the cylinder heads.

In known casting methods a ceramic filter is positioned in the liquid metal pour path upstream of the mold which filters out inclusions and oxides from the liquid metal, thereby improving casting purity. Known ceramic filters for liquid aluminum material pours are made of a ceramic foam which is suitable for the aluminum melt temperature. Such materials however are susceptible to non-uniform and inconsistent pore sizes and therefore may result in low filtration efficiency. The non-uniform and inconsistent pore sizes produce significant variation in metal flow rate through the filter and therefore through the system, which negatively impacts mold fill and cure times. Current ceramic foam filters cannot remove 100% of contaminants from the liquid aluminum and may have efficiencies as low as 60% to 70%.

Thus, while current ceramic filters used in liquid metal pour operations achieve their intended purpose, there is a need for a new and improved system and method for filtering inclusions and oxides from liquid metal during mold pour operation.

### SUMMARY

According to several aspects, a ceramic foam filter includes a filter body having portions forming multiple tortuous path channels through the filter body to filter a molten liquid, the molten liquid having multiple inclusions. An upstream end of the filter body is configured to receive the molten liquid. The multiple tortuous path channels being sized to trap a predominant portion of multiple oxides within the molten liquid as trapped oxides within the filter body.

In another aspect of the present disclosure, a melt treatment material is incorporated within the multiple tortuous path channels.

In another aspect of the present disclosure, the melt treatment material coated onto walls of the tortuous path channels.

In another aspect of the present disclosure, a melt treatment portion of the melt treatment material is captured by and incorporated into the molten material as the molten material traverses the multiple tortuous path channels.

In another aspect of the present disclosure, the melt treatment material includes at least one of a grain refiner, a eutectic modifier and a chemical fluxing.

In another aspect of the present disclosure, the grain refiner includes at least one of a titanium-boride material, a boride material, a lanthanum-boride material, a niobium material, a niobium-boride material, a titanium-magnesium-cerium material, a lanthanum-cerium material.

In another aspect of the present disclosure, the eutectic modifier includes a silicone modifier including one or more of a strontium (Sr) material, a sodium (Na) material, an antimony (Sb) material, a phosphorus (P) material, a calcium (Ca) material, a barium (Ba) material, an yttrium (Y) material, a europium (Eu) material, an ytterbium (Yb) material, a lanthanum (La) material, a cerium (Ce) material, a praseodymium (Pr) material, and a neodymium (Nd) material.

In another aspect of the present disclosure, the chemical fluxing includes at least one of an oxide film remover including a fluorine containing material or a fluorine-free material.

In another aspect of the present disclosure, sequential ones of the multiple tortuous path channels are oppositely facing, individual ones of the multiple tortuous path channels include multiple rounded slots.

In another aspect of the present disclosure, sequential ones of the multiple tortuous path channels are oppositely facing, individual ones of the multiple tortuous path channels include multiple rectangular-shaped slots.

According to several aspects, a ceramic foam filter system includes a filter body having multiple tortuous path channels through the filter body to filter a molten liquid. The filter body is placed inside a runner passage with a configuration like a canister. An upstream end of the filter body receives the molten liquid having multiple inclusions. A predominant portion of the inclusions are larger than the multiple tortuous path channels and are trapped against the upstream end of the filter body. The multiple tortuous path channels are sized to trap a predominant portion of multiple oxides within the molten liquid as trapped oxides within the filter body. A filtered molten material having the multiple inclusions and the multiple oxides removed is directed from the multiple tortuous path channels as a discharge flow to exit at a downstream end of the filter body.

In another aspect of the present disclosure, a mold creating a casting defines an aluminum cylinder head of an automobile vehicle.

In another aspect of the present disclosure, a feed portion having a gating system is connected to the mold.

In another aspect of the present disclosure, a pour basin into which the molten liquid is poured is included, the molten liquid flowing downward under gravity out of the pour basin through a sprue in a downward direction and passing through the filter configuration defining a canister in the runner including the ceramic foam filter.

In another aspect of the present disclosure, the molten material exits the ceramic foam filter as the filtered molten material and is directed into a horizontally oriented runner, and from the runner the filtered molten material is split and flows through multiple gates into the mold.

In another aspect of the present disclosure, a melt treatment material is incorporated within the multiple tortuous path channels by an additive manufacturing process, wherein as the filtered molten material traverses the multiple tortuous path channels a portion of the melt treatment material is captured by and incorporated into the filtered molten material as a melt treatment portion.

In another aspect of the present disclosure, the melt treatment material includes at least one of a grain refiner, a eutectic modifier and a chemical fluxing.

According to several aspects, a method for making a ceramic foam filter includes: combining ceramic powders and at least one binder in a combining operation; designing a ceramic foam filter cell geometry; printing a ceramic foam filter using the ceramic powders and the binder from the combining operation using an additive manufacturing operation; and sintering the ceramic foam filter at a sintering temperature above an anticipated temperature of a molten material to be filtered by the ceramic foam filter.

In another aspect of the present disclosure, the method further includes applying a cell surface treatment to the ceramic foam filter.

In another aspect of the present disclosure, the method further includes assembling the ceramic foam filter into a filter canister.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a front elevational cross-sectional view of a ceramic foam filter and filter holder configuration defining a canister in a runner passage according to an exemplary aspect;

FIG. 2 is a front left perspective view of a molten material pour system for producing a casting using the ceramic foam filter of FIG. 1;

FIG. 3 is a top left perspective view of a ceramic foam filter of FIG. 1 according to a first aspect;

FIG. 4 is a top left perspective view of a ceramic foam filter of FIG. 1 according to a second aspect;

FIG. 5 is a cross-sectional view taken at section 5 of FIG. 3;

FIG. 6 is a cross-sectional view taken at section 6 of FIG. 4; and

FIG. 7 is a flow diagram of exemplary method steps for forming the ceramic foam filter of FIG. 1.

### DETAILED DESCRIPTION

The following description is merely exemplary in nature and is not intended to limit the present disclosure, application, or uses.

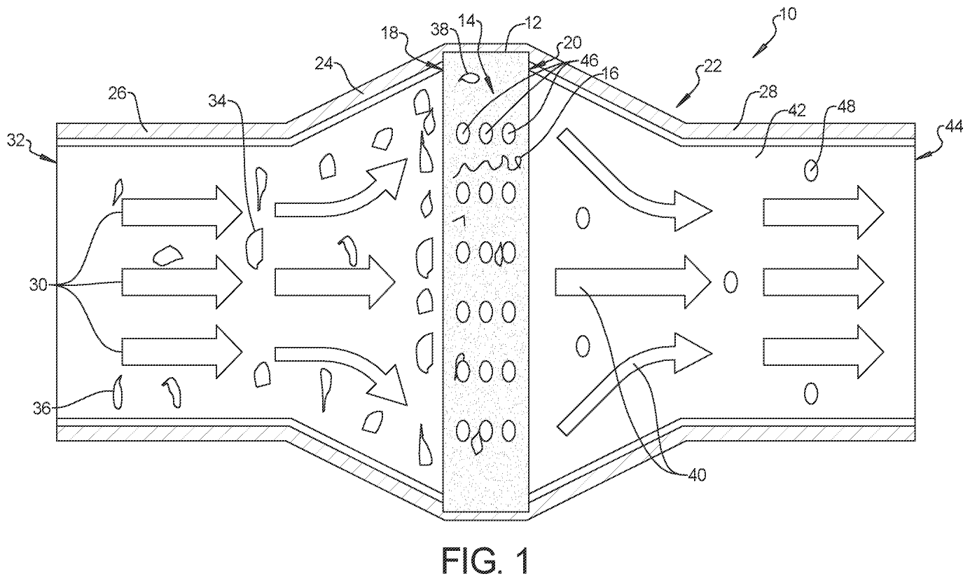

Referring to FIG. 1, a ceramic filter system 10 is presented which includes a ceramic foam filter 12 having a filter body 14 which provides multiple tortuous path channels 16 through the filter body 14 for filtering a molten liquid such as aluminum. A molten liquid discussed below enters the filter body 14 at an upstream end 18, traverses the filter body 14 via the multiple tortuous path channels 16 and discharges from the filter body 14 at a downstream end 20. The filter body 14 is positioned in a filter holder configuration defining a canister in a runner passage 22 having an enlarged portion 24 adapted to receive and retain the filter body 14. The filter holder configuration defining a canister in a runner passage 22 includes an inlet portion 26 upstream of the filter body 14 and an outlet portion 28 downstream of the filter body 14. Inlet flow of a molten liquid 30 such as heated, liquid aluminum is received at an inlet end 32 of the filter holder configuration defining a canister in a runner passage 22. The molten liquid 30 commonly carries inclusions 34 and oxides 36 of the molten liquid 30 which are undesirable, and therefore intended to be removed using the filter body 14.

As the molten liquid 30 encounters the filter body 14, a predominant portion of the inclusions 34 are too large to enter the multiple tortuous path channels 16 and are therefore trapped against the upstream end 18 of the filter body 14. The multiple tortuous path channels 16 are also sized to trap a predominant portion of the oxides 36 which are shown as trapped oxides 38 within the filter body 14. A filtered molten material 40 having the inclusions 34 and the oxides 36 removed is directed as a discharge flow 42 to exit the outlet portion 28 at an outlet end 44 of the filter holder configuration defining a canister in a runner passage 22.

According to several aspects, the filter body 14 is made using an additive manufacturing process and may be imprinted with a melt treatment material 46 incorporated within the multiple tortuous path channels 16. As the filtered molten material 40 traverses the multiple tortuous path channels 16 portions of the melt treatment material 46 are captured by and incorporated into the filtered molten material 40 as melt treatment portions 48. According to several aspects, the melt treatment material 46 may include at least one of a grain refiner, a eutectic modifier, a chemical fluxing, or the like. The grain refiner may be one or more of a titanium-boride (TiB) material, a boride (B) material, a lanthanum-boride (La—B) material, a niobium (Nb) material, a niobium-boride (Nb—B) material, a titanium-magnesium-cerium (Ti—Mg—Ce) material, a lanthanum-cerium (La—Ce) material, and the like. The eutectic modifier may define a silicone modifier including one or more of a strontium (Sr) material, a sodium (Na) material, an antimony (Sb) material, a phosphorus (P) material, a calcium (Ca) material, a barium (Ba) material, an yttrium (Y) material, a europium (Eu) material, an ytterbium (Yb) material, a lanthanum (La) material, a cerium (Ce) material, a praseodymium (Pr) material, a neodymium (Nd) material and the like. The chemical flux material may define an oxide film remover such as a Florine containing material or may be a Florine-free flux.

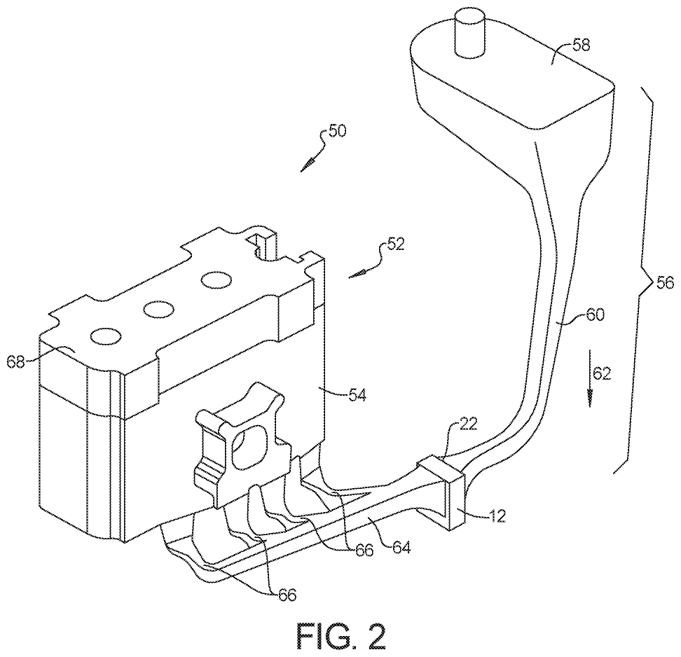

Referring to FIG. 2 and again to FIG. 1, according to several aspects the ceramic filter system 10 is incorporated in a mold fill system 50 and may be used to fill a semi-permanent mold 52, an end portion of which is shown, to produce a casting 54 defining for example an aluminum cylinder head for an automobile vehicle internal combustion engine (not shown). The molten liquid 30 is gravity fed into the mold 52 via a feed portion 56. The feed portion 56 provides a gating system which includes a pour basin 58 acting similar to a funnel into which the molten liquid 30 is poured. The molten liquid 30 flows downward under gravity out of the pour basin 58 through a sprue 60 in a downward direction 62, passes through the filter holder configuration defining a canister in a runner passage 22 including the ceramic foam filter 12, exits the ceramic foam filter 12 as the filtered molten material 40 and is directed into a generally horizontally oriented runner 64. From the runner 64, the filtered molten material 40 is split and flows through multiple gates 66 into the mold 52.

As the filtered molten material 40 fills the mold 52, to force a volume of the casting metal which may contain porosity away from the finished casting 54, an overflow of the filtered molten material 40 is a riser 68 generally above the mold 52 to feed the casting shrinkage during solidification, where cooling is slowest, and therefore where porosity may most likely occur. Due to expected contraction of the filtered molten material 40 during cooling, the size and volume of the riser 68 are predetermined to calculate a total volume of filtered molten material 40 to be added to the pour basin 58 and/or the sprue 60. To ensure gravity flow, an elevation of the pour basin 58 is predetermined to position the pour basin 58 at or above a maximum expected height of the riser 68. The sprue 60 and the runner 64 are sized to permit flow relying on gravity.

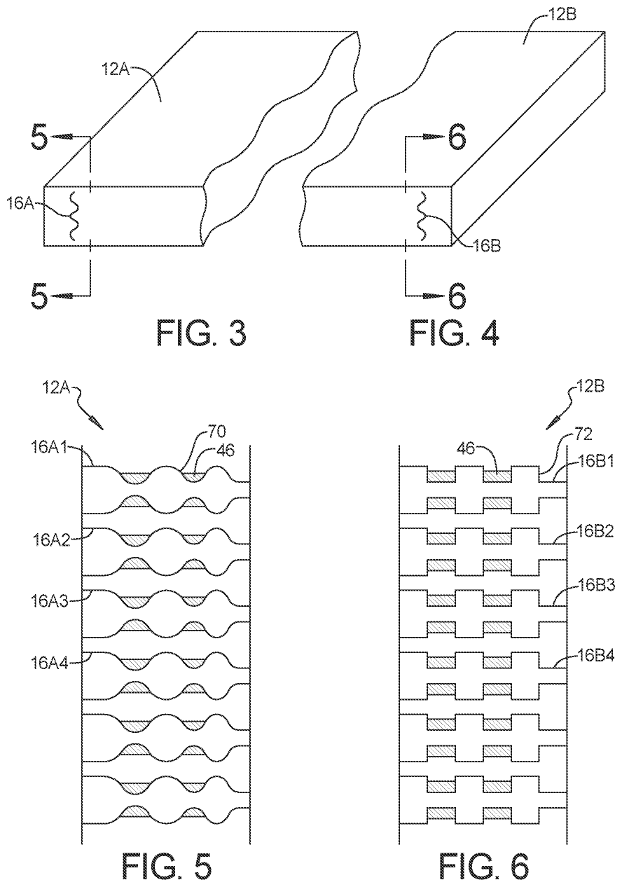

Referring to FIG. 3 and again to FIGS. 1 and 2, according to several aspects a first ceramic foam filter 12A includes melt treatment material positioned within multiple tortuous path channels 16A. The melt treatment material is shown and described in greater detail in reference to FIG. 5.

Referring to FIG. 4 and again to FIGS. 2 and 3, according to several aspects a second ceramic foam filter 12B includes melt treatment material positioned within multiple tortuous path channels 16B. The melt treatment material is shown and described in greater detail in reference to FIG. 6.

Referring to FIG. 5 and again to FIG. 3, exemplary ones of the multiple tortuous path channels 16A of the first ceramic foam filter 12A are depicted as tortuous path channels 16A1, 16A2, 16A3 and 16A4. According to several aspects, sequential ones of the multiple tortuous path channels 16A are oppositely facing, such as tortuous path channel 16A1 and tortuous path channel 16A2. Individual ones of the multiple tortuous path channels 16A include multiple rounded slots 70. Into individual ones of the rounded slots 70 is deposited the melt treatment material 46 during the additive manufacturing process. As previously noted as the molten material such as molten aluminum passes through the multiple tortuous path channels 16A of the first ceramic foam filter 12A the melt treatment material 46 melts and is carried with the molten material to become a portion of the filtered molten material 40.

Referring to FIG. 6 and again to FIG. 4, exemplary ones of the multiple tortuous path channels 16B of the second ceramic foam filter 12B are depicted as tortuous path channels 1661, 16B2, 16B3 and 16B4. According to several aspects, sequential ones of the multiple tortuous path channels 16B are oppositely facing, such as tortuous path channel 16B1 and tortuous path channel 16B2. Individual ones of the multiple tortuous path channels 16B include multiple rectangular-shaped slots 72. Into individual ones of the rectangular-shaped slots 72 is deposited the melt treatment material 46 during the additive manufacturing process. As previously noted as the molten material such as molten aluminum passes through the multiple tortuous path channels 16B of the second ceramic foam filter 12B the melt treatment material 46 melts and is carried with the molten material to become a portion of the filtered molten material 40.

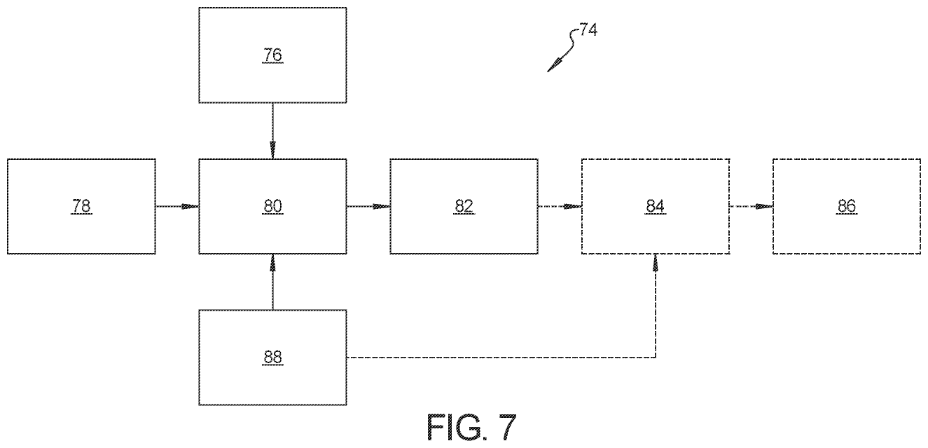

Referring to FIG. 7 and again to FIGS. 1 through 6, a method to manufacture a ceramic foam filter 74 includes combining ceramic powders and at least one binder in a combining operation 76. In a design operation 78 a filter cell geometry is designed and selected. In a printing operation 80 the ceramic foam filter selected from the design operation 78 is printed using the ceramic powders and the binder from the combining operation 76. Following the printing operation 80 the ceramic foam filter is sintered in a sintering operation 82 at a high temperature above an anticipated temperature of the molten material to be filtered such as molten aluminum. In a treatment operation 84 a cell surface treatment may be applied after the sintering operation is completed. Following the sintering operation 82 and the treatment operation 84 the completed ceramic foam filter body is assembled into the filter holder configuration defining a canister in a runner passage 22 described in reference to FIG. 1.

As noted above in reference to FIGS. 5 and 6, the melt treatment material 46 may be included during the additive manufacturing process when conducting the printing operation 80. A type and locations of the melt treatment material 46 are predetermined to achieve a geometry of the tortuous path channels 16.

A ceramic foam filter body of the present disclosure may be manufactured using an additive manufacturing process by directly printing ceramic powders and additive binders. Melt treatment materials or alloying elements may also be printed or integrated inside the ceramic foam filter body to further enhance melt cleanliness and microstructure refinement by allowing uniform release of the melt treatment material in the molten material flow stream. Control of filter geometry allows for effective removal of inclusions and material oxides during molten material flow through the filter body.

Uniform porous channel geometry and sized can be printed consistently throughout the ceramic foam filter body. The porous channel geometry patterns and sizes may be controlled using the additive manufacturing process. The additive manufacturing process produces complicated geometries which are accurate and repeatable throughout the internal features of the ceramic foam filter body. The ceramic foam filter body produced by the present disclosure provides improved efficiency, higher than 70%, compared to known ceramic filters used. One or multiple nozzles may be provided from one or multiple layer structures. Alloying materials may be added during the printing process such as for grain refinement, eutectic modifications, chemical fluxes, and the like. A filter cell roughness may be controlled or predetermined for any of the alloying materials selected by adjusting printing parameters or by adding a surface texture during production of a filter computer aided design (CAD) model.

A ceramic foam filter of the present disclosure offers several advantages. These include provision of a porous channel geometry and controlled filter channel size for filter consistency. Multiple different materials may be added having different wettability in the ceramic foam filter. A part of the filter or sections within multiple tortuous path channels may include melt treatment materials and alloying elements. The ceramic foam filter may be printed together with a mold such as an investment casting.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A ceramic foam filter, comprising:
a filter body having portions forming multiple tortuous path channels through the filter body to filter a molten liquid, the molten liquid having multiple inclusions;
an upstream end of the filter body configured to receive the molten liquid; and
the multiple tortuous path channels being sized to trap a predominant portion of multiple oxides within the molten liquid as trapped oxides within the filter body.

2. The ceramic foam filter of claim 1, further including a melt treatment material incorporated within the multiple tortuous path channels.

3. The ceramic foam filter of claim 2, having the melt treatment material coated onto walls of the tortuous path channels.

4. The ceramic foam filter of claim 3, further including a melt treatment portion of the melt treatment material, wherein as the molten material traverses the multiple tortuous path channels the melt treatment portion is captured by and incorporated into the molten material.

5. The ceramic foam filter of claim 3, wherein the melt treatment material includes at least one of a grain refiner, a eutectic modifier and a chemical fluxing.

6. The ceramic foam filter of claim 5, wherein the grain refiner includes at least one of a titanium-boride material, a boride material, a lanthanum-boride material, a niobium material, a niobium-boride material, a titanium-magnesium-cerium material, a lanthanum-cerium material.

7. The ceramic foam filter of claim 5, wherein the eutectic modifier includes a silicone modifier including one or more of a strontium (Sr) material, a sodium (Na) material, an antimony (Sb) material, a phosphorus (P) material, a calcium (Ca) material, a barium (Ba) material, an yttrium (Y) material, a europium (Eu) material, an ytterbium (Yb) material, a lanthanum (La) material, a cerium (Ce) material, a praseodymium (Pr) material, and a neodymium (Nd) material.

8. The ceramic foam filter of claim 5, wherein the chemical fluxing includes at least one of an oxide film remover including one of a fluorine containing material and a fluorine-free material.

9. The ceramic foam filter of claim 1, wherein sequential ones of the multiple tortuous path channels are oppositely facing, individual ones of the multiple tortuous path channels include multiple rounded slots.

10. The ceramic foam filter of claim 1, wherein sequential ones of the multiple tortuous path channels are oppositely facing, individual ones of the multiple tortuous path channels include multiple rectangular-shaped slots.

11. A ceramic foam filter system, comprising:
a filter body having multiple tortuous path channels through the filter body to filter a molten liquid;
a filter holder configuration defining a canister in a runner passage receiving the filter body;
an upstream end of the filter body receiving the molten liquid, the molten liquid having multiple inclusions, a predominant portion of the inclusions being larger than the multiple tortuous path channels and being trapped against the upstream end of the filter body;
the multiple tortuous path channels sized to trap a predominant portion of multiple oxides within the molten liquid as trapped oxides within the filter body; and
a filtered molten material having the multiple inclusions and the multiple oxides removed is directed from the multiple tortuous path channels as a discharge flow to exit at a downstream end of the filter body.

12. The ceramic foam filter system of claim 11, further including a mold creating a casting defining an aluminum cylinder head of an automobile vehicle.

13. The ceramic foam filter system of claim 12, further including a feed portion having a gating system connected to the mold.

14. The ceramic foam filter system of claim 13, including a pour basin into which the molten liquid is poured, the molten liquid flowing downward under gravity out of the pour basin through a sprue in a downward direction and pass through the filter holder configuration defining a canister in a runner passage including the filter body.

15. The ceramic foam filter system of claim 14, wherein the molten liquid exits the filter body as the filtered molten material and is directed into a horizontally oriented runner, and from the runner the filtered molten material is split and flows through multiple gates into the mold.

16. The ceramic foam filter system of claim 11, including a melt treatment material incorporated within the multiple tortuous path channels by an additive manufacturing process, wherein as the filtered molten material traverses the multiple tortuous path channels a portion of the melt treatment material is captured by and incorporated into the filtered molten material as a melt treatment portion.

17. The ceramic foam filter system of claim 16, wherein the melt treatment material includes at least one of a grain refiner, a eutectic modifier and a chemical fluxing.

18. A method for making a ceramic foam filter, comprising:
combining ceramic powders and at least one binder in a combining operation;
designing a ceramic foam filter cell geometry of a filter body;
printing the filter body using the ceramic powders and the binder from the combining operation using an additive manufacturing operation; and
sintering the filter body at a sintering temperature above an anticipated temperature of a molten material to be filtered by the filter body.

19. The method of claim 18, further including applying a cell surface treatment to the filter body.

20. The method of claim 19, further including assembling the filter body into a filter holder configuration defining a canister in a runner passage.
